(19) United States
(12) Patent Application Publication
(10) Pub. No.: US 2014/0247103 A1
(43) Pub. Date: Sep. 4, 2014

(54) METHOD OF MANUFACTURING AN ELECTRONIC COMPONENT

(71) Applicant: MURATA MANUFACTURING CO., LTD., Kyoto (JP)

(72) Inventor: Katsuyuki UCHIDA, Kyoto (JP)

(73) Assignee: MURATA MANUFACTURING CO., LTD., Kyoto (JP)

(21) Appl. No.: 14/249,293

(22) Filed: Apr. 9, 2014

Related U.S. Application Data
(62) Division of application No. 13/332,192, filed on Dec. 20, 2011, now Pat. No. 8,732,939.
Application No. 13/332,192 is a continuation of application No. PCT/JP2010/058449, filed on May 19, 2010.

(30) Foreign Application Priority Data
Jun. 24, 2009 (JP) 2009-149243

(51) Int. Cl. H01F 27/28

(52) U.S. Cl. CPC H01F 27/2804; H01F 2027/2809
USPC 336/200

(57) ABSTRACT

An electronic component capable of preventing the occurrence of magnetic saturation due to a magnetic flux surrounding each coil conductor and a method of manufacturing the electronic component are provided. The electronic component includes a laminate formed by stacking unit layers, where each unit layer includes a first insulating layer, and a coil conductor and second insulating layer formed on the first insulating layer. Each second insulating layer has a Ni content greater than a Ni content of each first insulating layer. Portions of the first insulating layers have a Ni content lower than a Ni content of the second portions after the laminate is calcined.

### CROSS REFERENCE TO RELATED APPLICATIONS

The present application is a continuation of International Application No. PCT/JP2010/058449 filed May 19, 2010, which claims priority to Japanese Patent Application No. 2009-149243 filed Jun. 24, 2009, the entire contents of each of these applications being incorporated herein by reference in their entirety.

### TECHNICAL FIELD

The present invention relates to electronic components and method of manufacturing the same and particularly relates to an electronic component including a coil and a method of manufacturing the same.

### BACKGROUND

Conventional electronic components known as open magnetic circuit-type laminated coil components are disclosed in, for example, Japanese Unexamined Patent Application Publication No. 2005-259774 (Patent Literature 1). FIG. 8 is a sectional view of an open magnetic circuit-type laminated coil component 500 disclosed in Patent Literature 1.

As shown in FIG. 8, the open magnetic circuit-type laminated coil component 500 includes a laminate 502 and a coil L. The laminate 502 is composed of a plurality of laminated magnetic layers. The coil L has a spiral shape and includes a plurality of coil conductors 506 connected to each other. The open magnetic circuit-type laminated coil component 500 further includes a non-magnetic layer 504. The non-magnetic layer 504 is placed in the laminate 502 so as to cross the coil L.

In the open magnetic circuit-type laminated coil component 500, a magnetic flux φ500 surrounding the coil conductors 506 passes through the non-magnetic layer 504. This prevents the occurrence of magnetic saturation due to the excessive concentration of the magnetic flux in the laminate 502. Therefore, the open magnetic circuit-type laminated coil component 500 has excellent direct current superposition characteristics.

### SUMMARY

The present disclosure provides an electronic component capable of preventing the occurrence of magnetic saturation due to a magnetic flux surrounding each coil conductor and a method of manufacturing the electronic component.

In one aspect of the disclosure, a method of manufacturing an electronic component includes steps of forming a laminate and calcining the laminate. The laminate includes a spiral coil including a plurality of connected coil conductors overlapping each other in plan view in a stacking direction, and a plurality of continuously stacked unit layers. Each of the unit layers includes a first insulating layer overlaid with one of the coil conductors and a second insulating layer having a greater Ni content than the first insulating layer. Each of the second insulting layers of the first unit layers is provided on portions of the first insulating layer other than where the one coil conductor is formed.

In another aspect of the disclosure, an electronic component includes a plurality of unit layers. Each of the unit layers include a single sheet-shaped first insulating layer, a coil conductor on the first insulating layer, and a second insulating layer on a portion of the first insulating layer other than where the coil conductor is provided. The unit layers are continuously stacked such that the coil conductors are connected to each other to form a spiral coil. The first insulating layers include first portions sandwiched between the coil conductors in the stacking direction and second portions other than the first portions. The first portions have a Ni content lower than a Ni content of the second portions. The Ni content of the second portions is lower than a Ni content of the second insulating layers.

### BRIEF DESCRIPTION OF DRAWINGS

FIG. 1 is a perspective view of an electronic component according to an exemplary embodiment.

FIG. 2 is an exploded perspective view of a laminate included in an electronic component according to the embodiment.

FIG. 3 is a sectional view of the electronic component taken along the line A-A of FIG. 1.

FIG. 4 is a graph showing simulation results.

FIG. 5 is a structural sectional view of an electronic component according to a first exemplary modification.

FIG. 6 is a structural sectional view of an electronic component according to a second exemplary modification.

FIG. 7 is a structural sectional view of an electronic component according to a third exemplary modification.

FIG. 8 is a sectional view of an open magnetic circuit-type laminated coil component disclosed in Patent Literature 1.

### DETAILED DESCRIPTION

The inventor realized that in the open magnetic circuit-type laminated coil component 500, a magnetic flux φ502 surrounding each coil conductor 506 is present in addition to the magnetic flux φ500 surrounding the coil conductors 506. The magnetic flux φ502 causes magnetic saturation in the open magnetic circuit-type laminated coil component 500.

Electronic components according to exemplary embodiments of the disclosure, which are capable of preventing the occurrence of magnetic saturation due to a magnetic flux surrounding each coil conductor, and methods of manufacturing the electronic components, will now be described.

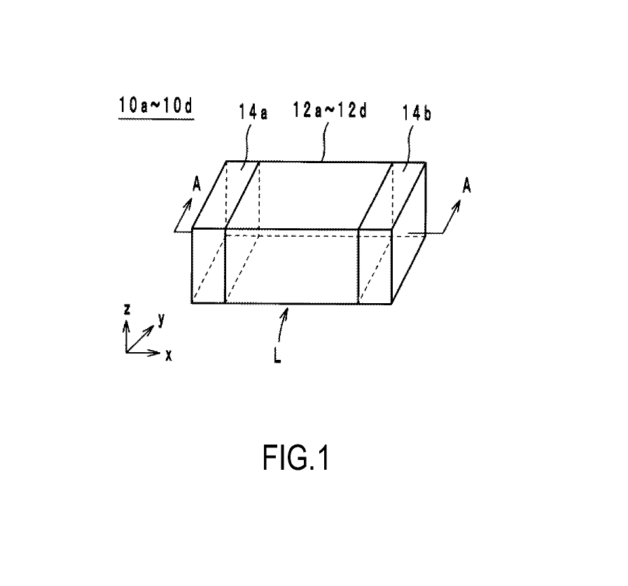

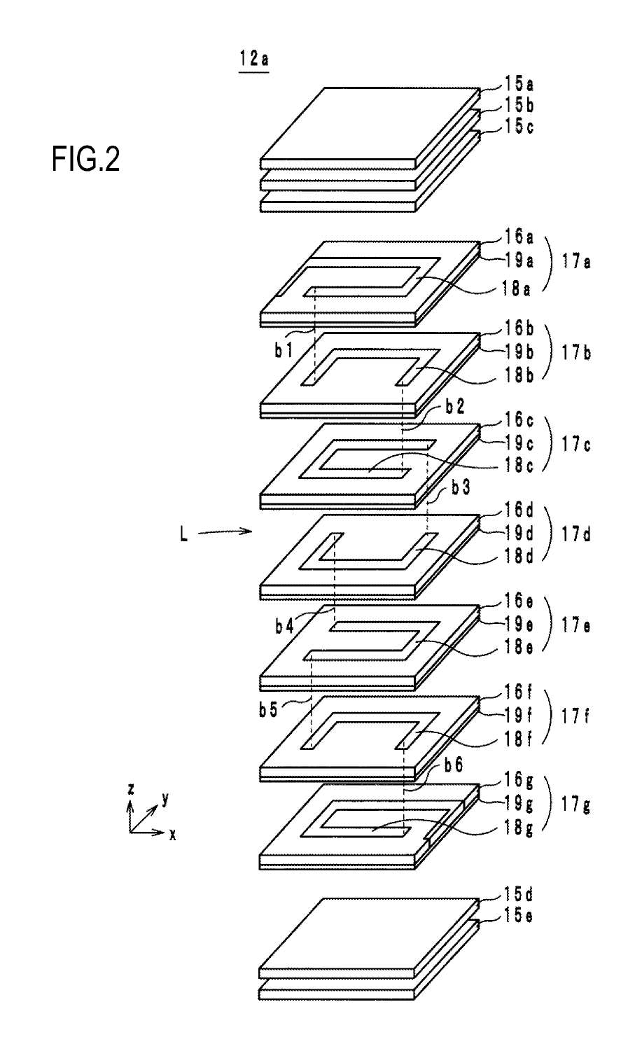

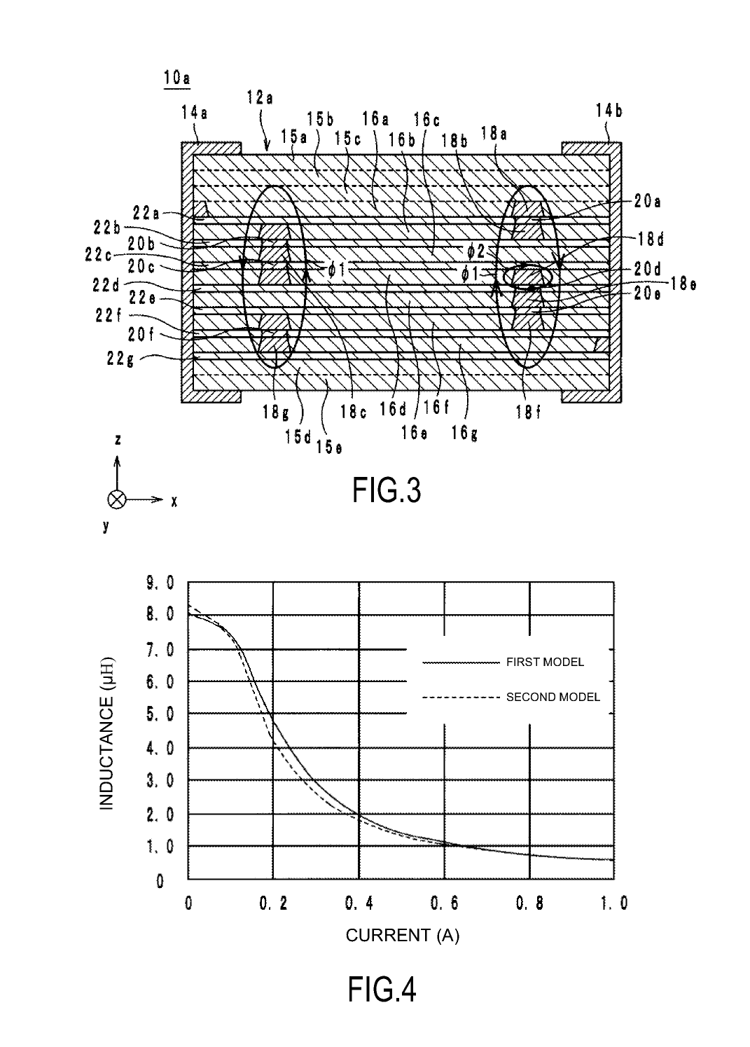

An electronic component according to an exemplary embodiment is described below with reference to FIGS. 1-3. FIG. 1 is a perspective view of electronic components 10a to 10d according to embodiments. FIG. 2 is an exploded perspective view of a laminate 12a included in the electronic component 10a according to an embodiment. FIG. 3 is a structural sectional view of the electronic component 10a taken along the line A-A of FIG. 1. The laminate 12a shown in FIG. 2 is in an uncalcined state. The electronic component 10a shown in FIG. 3 is in a calcined state calcination. Hereinafter, the stacking direction of the electronic component 10a is defined as a z-axis direction, a direction along a long side of the electronic component 10a is defined as an x-axis direction, and a direction along a short side of the electronic component 10a is defined as a y-axis direction. The x-axis, y-axis, and z-axis are orthogonal to each other.

With reference to FIG. 1, the electronic component 10a includes the laminate 12a and external electrodes 14a and 14b. The laminate 12a has a rectangular parallelepiped shape and includes a coil L (not explicitly shown in FIG. 1). The external electrodes 14a and 14b are electrically connected to the coil L and are each arranged on a corresponding one of side surfaces of the laminate 12a that are opposed to each other. In this embodiment, the external electrodes 14a and 14b are arranged to cover the two side surfaces, which are located at both ends of the component in the x-axis direction.

As shown in FIG. 2, the laminate 12a is composed of insulating layers 15a to 15e, 16a to 16g, and 19a to 19g; coil conductors 18a to 18g; and via-hole conductors b1 to b6. Each of the insulating layers 15a to 15e has a rectangular shape and is a single sheet-shaped magnetic layer made of Ni—Cu—Zn ferrite. The insulating layers 15a to 15c are stacked in that order on the positive side of a region containing the coil conductors 18a to 18g in the z-axis direction and form a covering. The insulating layers 15d and 15e are stacked in that order on the negative side of the region containing the coil conductors 18a to 18g in the z-axis direction and form another covering.

As shown in FIG. 2, the insulating layers 19a to 19g are rectangular and have a first Ni content. In this embodiment, the insulating layers 19a to 19g are non-magnetic layers made of Cu—Zn ferrite containing no Ni. The uncalcined insulating layers 19a to 19g are non-magnetic; however, the calcined insulating layers 19a to 19g are partly magnetic. This is described below.

As shown in FIG. 2, the coil conductors 18a to 18g are made of a conductive material containing Ag, have a length equal to a ¾ turn, and form the coil L together with the via-hole conductors b1 to b6. The coil conductors 18a to 18g are each arranged on a corresponding one of the insulating layers 19a to 19g. One end of the coil conductor 18a is exposed on a side of the insulating layer 19a that is located on a negative side of the insulating layer in the x-axis direction and serves as a lead conductor. This end of the coil conductor 18a is connected to the external electrode 14a shown in FIG. 1. One end of the coil conductor 18g is exposed on the positive side of the insulating layer 19g in the x-axis direction and serves as a lead conductor. This end of the coil conductor 18g is connected to the external electrode 14b shown in FIG. 1. The coil conductors 18a to 18g overlap each other to form a single rectangular ring in plan view in the z-axis direction.

As shown in FIG. 2, the via-hole conductors b1 to b6 extend through the insulating layers 19a to 19f in the z-axis direction and connect the coil conductors 18a to 18g neighboring each other in the z-axis direction. In particular, the via-hole conductor b1 connects the other end of the coil conductor 18a to one end of the coil conductor 18b. The via-hole conductor b2 connects the other end of the coil conductor 18b to one end of the coil conductor 18c. The via-hole conductor b3 connects the other end of the coil conductor 18c to one end of the coil conductor 18d. The via-hole conductor b4 connects the other end of the coil conductor 18d to one end of the coil conductor 18e. The via-hole conductor b5 connects the other end of the coil conductor 18e to one end of the coil conductor 18f. The via-hole conductor b6 connects the other end of the coil conductor 18f to the other end of the coil conductor 18g (one end of the coil conductor 18g serves as a lead conductor, as described above). As described above, the coil conductors 18a to 18g and the via-hole conductors b1 to b6 form the coil L. The coil L has a coil axis extending in the z-axis direction and is spiral.

As shown in FIG. 2, the insulating layers 16a to 16g are arranged on portions of the insulating layers 19a to 19g other than the coil conductors 18a to 18g. Therefore, principal surfaces of the insulating layers 19a to 19g are covered with the insulating layers 16a to 16g and the coil conductors 18a to 18g. A principal surface of each of the insulating layers 16a to 16g and a principal surface of a corresponding one of the coil conductors 18a to 18g form a single plane and are flush with each other. The insulating layers 16a to 16g have a second Ni content higher than the first Ni content. In this embodiment, the insulating layers 16a to 16g are magnetic layers made of Ni—Cu—Zn ferrite.

The insulating layers 19a to 19g are thinner than the insulating layers 16a to 16g. In particular, the insulating layers 19a to 19g have a thickness of 5 μm to 15 μm and the insulating layers 16a to 16g have a thickness of 25 μm.

The insulating layers 16a to 16g and 19a to 19g and coil conductors 18a to 18g configured as described above form unit layers 17a to 17g. The unit layers 17a to 17g are continuously arranged between a group of the insulating layers 15a to 15c and a group of the insulating layers 15d and 15e in that order, thereby forming the laminate 12a.

After the laminate 12a is calcined and the external electrodes 14a and 14b are formed thereon, the electronic component 10a has a cross-sectional structure as shown in FIG. 3. In particular, the Ni content of portions of the insulating layers 19a to 19g is increased to exceed the first Ni content during the calcination of the laminate 12a. That is, during calcination the insulating layers 19a to 19g are partly transformed from non-magnetic layers to magnetic layers.

As shown in FIG. 3 in detail, in the electronic component 10a, the insulating layers 19a to 19g include first portions 20a to 20f and second portions 22a to 22g. The first portions 20a to 20f correspond to portions of the insulating layers 19a to 19f that are sandwiched between the coil conductors 18a to 18g in the z-axis direction. In particular, the first portion 20a corresponds to a portion of the insulating layer 19a that is sandwiched between the coil conductors 18a and 18b. The first portion 20b corresponds to a portion of the insulating layer 19b that is sandwiched between the coil conductors 18b and 18c. The first portion 20c corresponds to a portion of the insulating layer 19c that is sandwiched between the coil conductors 18c and 18d. The first portion 20d corresponds to a portion of the insulating layer 19d that is sandwiched between the coil conductors 18d and 18e. The first portion 20e corresponds to a portion of the insulating layer 19e that is sandwiched between the coil conductors 18e and 18f. The first portion 20f corresponds to a portion of the insulating layer 19f that is sandwiched between the coil conductors 18f and 18g. The second portions 22a to 22g correspond to portions of the insulating layers 19a to 19f other than the first portions 20a to 20f. However, no first portion (i.e., no portion “20g”) is present in the insulating layer 19g, but the second portion 22g is present in that layer. This is because the insulating layer 19g is located on a more negative side in the z-axis direction as compared with the insulating layer 18g, which is located on the most negative side in the z-axis direction.

The first portions 20a to 20f have a Ni content lower than the Ni content of the second portions 22a to 22g. In this embodiment, the first portions 20a to 20f contain no Ni. Therefore, the first portions 20a to 20f are non-magnetic. In contrast, the second portions 22a to 22g contain Ni. Therefore, the second portions 22a to 22g are magnetic. The Ni content of the second portions 22a to 22g is lower than the Ni content of the insulating layers 16a to 16g.

A method of manufacturing the electronic component 10a is now described below with reference to FIG. 2. In the method, the electronic component 10a is manufactured together with a plurality of electronic components 10a as described below.

Ceramic green sheets for forming the insulating layers 19a to 19g are prepared as shown in FIG. 2. In particular, raw materials are prepared by weighing ferric oxide (Fe₂O₃), zinc oxide (ZnO), and copper oxide (CuO) at a predetermined ratio and are charged into a ball mill, followed by wet mixing. An obtained mixture is dried and is then pulverized. An obtained powder is calcined at 800° C. for one hour. The calcined powder is wet-pulverized in a ball mill, is dried, and is then disintegrated, whereby a ferrite ceramic powder is obtained.

The ferrite ceramic powder is mixed with a binder (vinyl acetate, a water-soluble acrylic resin, or the like), a plasticizer, a humectant, and a dispersant in a ball mill, followed by defoaming under reduced pressure. An obtained ceramic slurry is formed into sheets on a carrier sheet by a doctor blade process and the sheets are dried, whereby the ceramic green sheets for forming the insulating layers 19a to 19g are prepared.

Ceramic green sheets for forming the insulating layers 15a to 15e are prepared as shown in FIG. 2. In particular, raw materials are prepared by weighing ferric oxide (Fe₂O₃), zinc oxide (ZnO), nickel oxide (NiO), and copper oxide (CuO) at a predetermined ratio and are charged into a ball mill, followed by wet mixing. An obtained mixture is dried and is then pulverized. An obtained powder is calcined at 800° C. for one hour. The calcined powder is wet-pulverized in a ball mill, is dried, and is then disintegrated, whereby a ferrite ceramic powder is obtained.

This ferrite ceramic powder is mixed with a binder (vinyl acetate, a water-soluble acrylic resin, or the like), a plasticizer, a humectant, and a dispersant in a ball mill, followed by defoaming under reduced pressure. An obtained ceramic slurry is formed into sheets on a carrier sheet by a doctor blade process and the sheets are dried, whereby the ceramic green sheets for forming the insulating layers 15a to 15e are prepared.

Ceramic green sheets for forming the insulating layers 16a to 16g are prepared as shown in FIG. 2. In particular, raw materials are prepared by weighing ferric oxide (Fe₂O₃), zinc oxide (ZnO), nickel oxide (NiO), and copper oxide (CuO) at a predetermined ratio and are charged into a ball mill, followed by wet mixing. An obtained mixture is dried and is then pulverized. An obtained powder is calcined at 800° C. for one hour. The calcined powder is wet-pulverized in a ball mill, is dried, and is then disintegrated, whereby a ferrite ceramic powder is obtained.

This ferrite ceramic powder is mixed with a binder (vinyl acetate, a water-soluble acrylic resin, or the like), a plasticizer, a humectant, and a dispersant in a ball mill, followed by defoaming under reduced pressure, whereby a ceramic slurry for ceramic layers for forming the insulating layers 16a to 16g is obtained.

As shown in FIG. 2, the via-hole conductors b1 to b6 are each formed on a corresponding one of the ceramic green sheets for forming the insulating layers 19a to 19f. In particular, a laser beam is applied to the ceramic green sheets for forming the insulating layers 19a to 19f, whereby via-holes are formed therein. The via-holes are filled with a conductive paste containing Ag, Pd, Cu, Au, an alloy thereof, or the like by a process such as printing or painting.

As shown in FIG. 2, the coil conductors 18a to 18g are formed on the ceramic green sheets for forming the insulating layers 19a to 19g. In particular, a conductive paste made of Ag, Pd, Cu, Au, an alloy thereof, or the like is applied to the ceramic green sheets for forming the insulating layers 19a to 19g by a process such as screen printing or photolithography, whereby the coil conductors 18a to 18g are formed. The formation of the coil conductors 18a to 18g and the filling of the via-holes with the conductive paste can be performed in the same step or in different steps.

As shown in FIG. 2, ceramic green layers for forming the insulating layers 16a to 16g are formed on portions of the ceramic green sheets for forming the insulating layers 19a to 19g, the portions being other than the coil conductors 18a to 18g. In particular, a ceramic paste is applied thereto by a process such as screen printing or photolithography, whereby the ceramic green layers for forming insulating layers 16a to 16g are formed. Through the above steps, ceramic green layers for forming the unit layers 17a to 17g are formed as shown in FIG. 2.

As shown in FIG. 2, the ceramic green sheets for forming the insulating layers 15a to 15c, the ceramic green layers for forming the unit layers 17a to 17g, and the ceramic green sheets for forming the insulating layers 15d and 15e are stacked in that order and are then press-bonded, whereby an uncalcined mother laminate is obtained. In particular, the ceramic green sheets for forming the insulating layers 15a to 15c, the ceramic green layers for forming the unit layers 17a to 17g, and the ceramic green sheets for forming the insulating layers 15d and 15e are stacked one by one and are preliminarily press-bonded and the uncalcined mother laminate is then pressed by isostatic pressing, whereby final press bonding is performed.

The coil L is formed during stacking because the ceramic green layers for forming the unit layers 17a to 17g are continuously arranged in the z-axis direction. This allows the coil conductors 18a to 18g and the insulating layers 19a to 19g to be alternately arranged in the uncalcined mother laminate in the z-axis direction as shown in FIG. 2.

The mother laminate is cut into laminates 12a with a predetermined size (2.5 mm×2.0 mm×1.0 mm) with a cutting blade, whereby the uncalcined laminates 12a are obtained. The uncalcined laminates 12a are degreased and are calcined. Degreasing is performed at, for example, 500° C. for two hours in a low-oxygen atmosphere. Calcination is performed at, for example, 870-900° C. for 2.5 hours.

During calcination, Ni diffuses from the insulating layers 15c, 16a to 16g, and 15d to the insulating layers 19a to 19g. In particular, the second portions 22a to 22g of the insulating layers 19a to 19g are in contact with the insulating layers 15c, 16a to 16g, and 15d as shown in FIG. 3 and therefore Ni diffuses from the insulating layers 15c, 16a to 16g, and 15d to the second portions 22a to 22g. Therefore, the second portions 22a to 22g become magnetized. The Ni content of the second portions 22a to 22g is lower than the second Ni content of the insulating layers 15c, 16a to 16g, and 15d.

In contrast, the first portions 20a to 20f of the insulating layers 19a to 19f are not in contact with the insulating layers 15c, 16a to 16g, and 15d and therefore no Ni diffuses from the insulating layers 15c, 16a to 16g, and 15d to the first portions 20a to 20f. Thus, the first portions 20a to 20f remain non-magnetic. The first portions 20a to 20f originally contain no Ni and, however, can contain Ni, which diffuses from the second portions 22a to 22g. Therefore, the first portions 20a to 20f, while essentially free of Ni, may contain a slight or a trace amount of Ni so as not be magnetic.

Through the above steps, the calcined laminates 12a are obtained. The laminates 12a are chamfered by barreling. An electrode paste made of silver is applied to the laminates 12a by, for example, a dipping process or the like and the laminates 12a are then baked, whereby silver electrodes for forming external electrodes 14a and 14b are formed. The silver electrodes are baked at 800° C. for one hour.

Finally, the silver electrodes are plated with Ni and Sn, whereby the external electrodes 14a and 14b are formed. Through the above steps, the electronic component 10a shown in FIG. 1 is completed.

In the electronic component 10a and the method, the occurrence of magnetic saturation due to a magnetic flux surrounding each of the coil conductors 18a to 18f can be prevented as described below. In particular, as shown in FIG. 3, when a current flows through the coil L of the electronic component 10a, a magnetic flux y1 which has a relatively long flux path and which entirely surrounds the coil conductors 18a to 18f is generated and magnetic fluxes y2 which have a relatively short flux path and which each surround a corresponding one of the coil conductors 18a to 18f are generated (only a magnetic flux y2 surrounding the coil conductor 18d is shown in FIG. 3). The magnetic fluxes y2, as well as the magnetic flux y1, can cause magnetic saturation in the electronic component 10a.

In each electronic component 10a manufactured by the method, the first portions 20a to 20f of the insulating layers 19a to 19f are sandwiched between the coil conductors 18a to 18g in the z-axis direction and are non-magnetic. Therefore, the magnetic fluxes φ2, which each surround a corresponding one of the coil conductors 18a to 18f, pass through the first portions 20a to 20f, which are non-magnetic. Thus, the magnetic fluxes φ2 have excessively high flux density; hence, magnetic saturation is prevented from occurring in the electronic component 10a. This allows the electronic component 10a to have enhanced direct current superposition characteristics.

The inventor has performed computer simulations as described below for the purpose of clarifying effects resulting from the electronic component 10a and the method. In particular, a first model corresponding to the electronic component 10a and a second model including magnetic layers corresponding to the insulating layers 19a to 19g of the electronic component 10a have been manufactured. Simulation conditions are as described below:

The number of turns in the coil L: 8.5 turns

The size of the electronic component: 2.5 mm×2.0 mm×1.0 mm

The thickness of the insulating layers 19a to 19g: 10 μm

FIG. 4 is a graph showing the simulation results. The ordinate represents the inductance and the abscissa represents the current. As is clear from FIG. 4, the inductance of the first model decreases more gently with an increase in current as compared to the second model. That is, the first model has direct current superposition characteristics more excellent than those of the second model. This means that magnetic saturation is more likely to occur due to a magnetic flux surrounding each coil electrode in the second model than the first model. As is clear from the above, in the electronic component 10a and the method, magnetic saturation can be prevented from occurring due to the magnetic fluxes φ2, which each surround a corresponding one of the coil conductors 18a to 18f.

In the electronic component 10a and the method, non-magnetic layers are the first portions 20a to 20f, which are sandwiched between the coil conductors 18a to 18f. Thus, the magnetic flux φ1, which surrounds the coil conductors 18a to 18f, does not pass through any non-magnetic layer. Therefore, the electronic component 10a can achieve high inductance.

In the electronic component 10a and the method, the first portions 20a to 20f, which are non-magnetic, can be accurately formed. In a common electronic component, in order to form a non-magnetic layer on a portion sandwiched between coil conductors, a process of applying a non-magnetic paste to the portion sandwiched between the coil conductors by printing may be used.

However, in the case of using the process of applying the non-magnetic paste thereto, the non-magnetic layer may possibly extend outside the portion sandwiched between the coil conductors because of misprinting or misalignment. When the non-magnetic layer extends outside the portion sandwiched between the coil conductors, the non-magnetic layer may possibly disturb a magnetic flux which entirely surrounds the coil conductors and which has a long flux path. That is, a magnetic flux other than a desired magnetic flux passes through the non-magnetic layer.

In the electronic component 10a and the method, after the laminate 12a is prepared, the first portions 20a to 20f, which are non-magnetic, are formed during calcination. Therefore, misprinting or misalignment does not cause the first portions 20a to 20f to extend outside portions sandwiched between the coil conductors 18a to 18f. In the electronic component 10a and the method, the first portions 20a to 20f, which are non-magnetic, can be accurately formed. Therefore, unlike the desired magnetic fluxes φ2, the magnetic flux φ1 is prevented from passing through any non-magnetic layer.

In the electronic component 10a, the unit layers 17a to 17g are continuously arranged between a group of the insulating layers 15a to 15c and a group of the insulating layers 15d and 15e in that order. This allows non-magnetic layers to be present only in the first portions 20a to 20f, which are sandwiched between the coil conductors 18a to 18g. Therefore, no non-magnetic layer crossing the coil L is present.

In the electronic component 10a and the method, the insulating layers 19a to 19g preferably have a thickness of 5 μm to 15 μm. When the thickness of the insulating layers 19a to 19g is less than 5 μm, it is difficult to prepare the ceramic green sheets for forming the insulating layers 19a to 19g. In contrast, when the thickness of the insulating layers 19a to 19g is more than 15 μm, Ni does not diffuse sufficiently and therefore it is difficult to magnetize the second portions 22a to 22g.

No non-magnetic layer crossing the coil L is present in the electronic component 10a. However, in the electronic component 10a, non-magnetic layers may be present on portions other than the first portions 20a to 20f. This is because direct current superposition characteristics of the electronic component and the inductance thereof can be adjusted using such non-magnetic layers. Electronic components, according to modifications, including non-magnetic layers placed on portions other than the first portions 20a to 20f are now described.

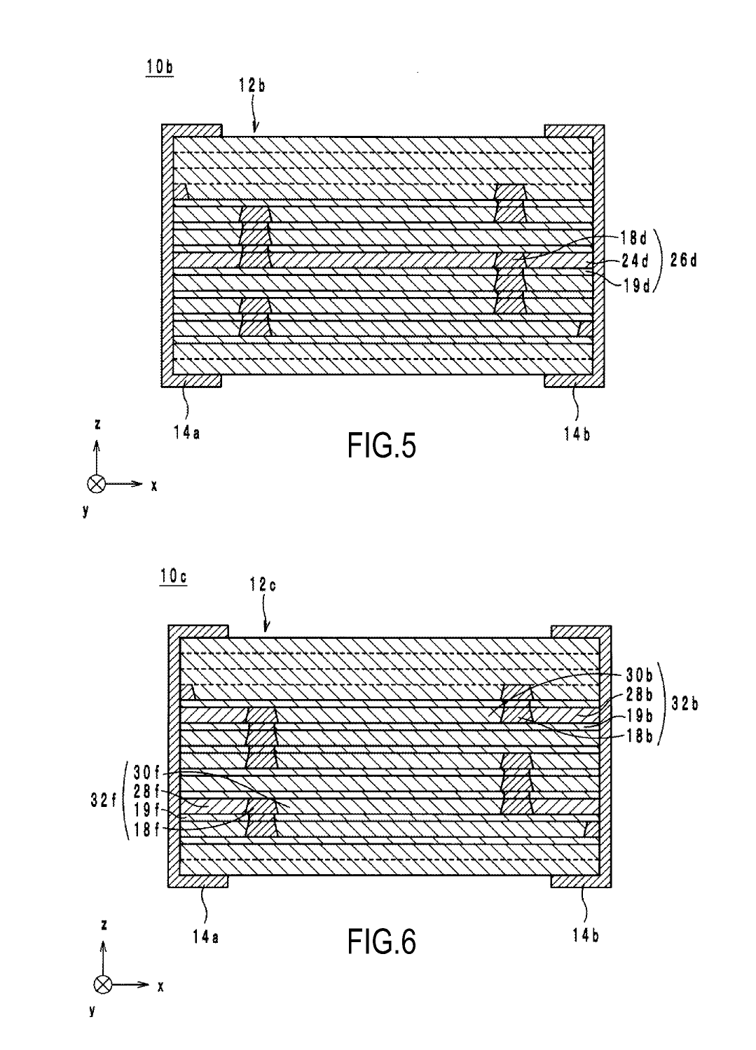

An electronic component 10b according to a first exemplary modification and an exemplary method of manufacturing the electronic component 10b are now described with reference to FIG. 5, which is a structural sectional view of the electronic component 10b according to the first exemplary modification. In order to avoid the complexity of FIG. 5, some of reference numerals representing the same members as those shown in FIG. 3, which can be present in the first exemplary modification, are not shown in FIG. 5.

A difference between the electronic component 10a and the electronic component 10b is that the electronic component 10b includes an insulating layer 24d which is non-magnetic instead of the insulating layer 16d, which is magnetic. This allows the insulating layer 24d, which is non-magnetic, to cross a coil L. Therefore, magnetic saturation due to a magnetic flux φ1 is prevented from occurring in the electronic component 10b.

In the exemplary method of manufacturing the electronic component 10b, a via-hole conductor b4 is formed in a ceramic green sheet for forming an insulating layer 19d. A procedure for forming the via-hole conductor b4 is as described above and therefore will not be repeated here.

A coil conductor 18d is formed on the ceramic green sheet for forming the insulating layer 19d. A procedure for forming the coil conductor 18d is as described above and therefore will not be repeated here.

A ceramic green layer for forming the insulating layer 24d is formed on a portion of the ceramic green sheet for forming the insulating layer 19d, the portion being other than the coil conductor 18d. In particular, the ceramic green layer for forming the insulating layer 24d is formed in such a manner that a non-magnetic paste is applied to the portion by a process such as screen printing or photolithography. Through the above steps, a ceramic green layer for forming a unit layer 26d is formed.

Ceramic green sheets for forming insulating layers 15a to 15c; ceramic green layers for forming unit layers 17a to 17c, 26d, and 17e to 17g; and ceramic green sheets for forming insulating layers 15d and 15e are stacked in that order and are then press-bonded, whereby an uncalcined mother laminate is obtained. Other steps of the method of manufacturing the electronic component 10b are the same as those of the method of manufacturing the electronic component 10a and therefore will not be repeated here.

An electronic component 10c according to a second exemplary modification and an exemplary method of manufacturing the electronic component 10c are now described with reference to FIG. 6, which is a structural sectional view of the electronic component 10c according to the second modification. In order to avoid the complexity of FIG. 6, some of reference numerals representing the same members as those shown in FIG. 3, which can be present in the second exemplary modification, are not shown in FIG. 6.

A difference between the electronic component 10a and the electronic component 10c is that the electronic component 10c includes insulating layers 28b and 28f which are non-magnetic and insulating layers 30b and 30f which are magnetic instead of the insulating layers 16b and 16f, which are magnetic. That is, in the electronic component 10c, the insulating layers 28b and 28f, which are non-magnetic, are arranged outside a coil L. This allows a magnetic flux φ1 to pass through the insulating layers 30b and 30f, which are magnetic, thereby preventing magnetic saturation due to the magnetic flux φ1 from occurring in the electronic component 10c.

In the exemplary method of manufacturing the electronic component 10c, via-hole conductor b2 and b6 are formed in ceramic green sheets for forming insulating layers 19b and 19f. A procedure for forming the via-hole conductors b2 and b6 is as described above and therefore will not be repeated here.

Coil conductors 18b and 18f are formed on the ceramic green sheets for forming the insulating layers 19b and 19f. A procedure for forming the coil conductors 18b and 18f is as described above and therefore will not be described.

Ceramic green layers for forming the insulating layers 28b and 30b are formed on portions of the ceramic green sheet for forming the insulating layer 19b, the portions being other than the coil conductor 18b. Ceramic green layers for forming the insulating layers 28f and 30f are formed on portions of the ceramic green sheet for forming the insulating layer 19f, the portions being other than the coil conductor 18f. In particular, the insulating layers 28b and 28f are formed on portions of the ceramic green sheets for forming the insulating layers 19b and 19f, the portions being outside the coil conductors 18b and 18f. The insulating layers 30b and 30f are formed on portions of the ceramic green sheets for forming the insulating layers 19b and 19f, the portions being inside the coil conductors 18b and 18f. The ceramic green layers for forming the insulating layers 28b and 28f are made from a non-magnetic ceramic paste (that is, a ceramic paste containing no Ni). The ceramic green layers for forming the insulating layers 30b and 30f are made from a magnetic ceramic paste (that is, a ceramic paste containing Ni). The magnetic and non-magnetic ceramic pastes are applied to the portions by a process such as screen printing or photolithography, whereby the ceramic green layers for forming the insulating layers 28b, 28f, 30b, and 30f are formed. Through the above steps, ceramic green layers for forming unit layers 32b and 32f are formed.

Ceramic green sheets for forming insulating layers 15a to 15c; ceramic green layers for forming unit layers 17a, 32b, 17c to 17e, 32f, and 17g; and ceramic green sheets for forming insulating layers 15d and 15e are stacked in that order and are then press-bonded, whereby an uncalcined mother laminate is obtained. Other steps of the method of manufacturing the electronic component 10c are the same as those of the method of manufacturing the electronic component 10a and therefore will not be repeated here.

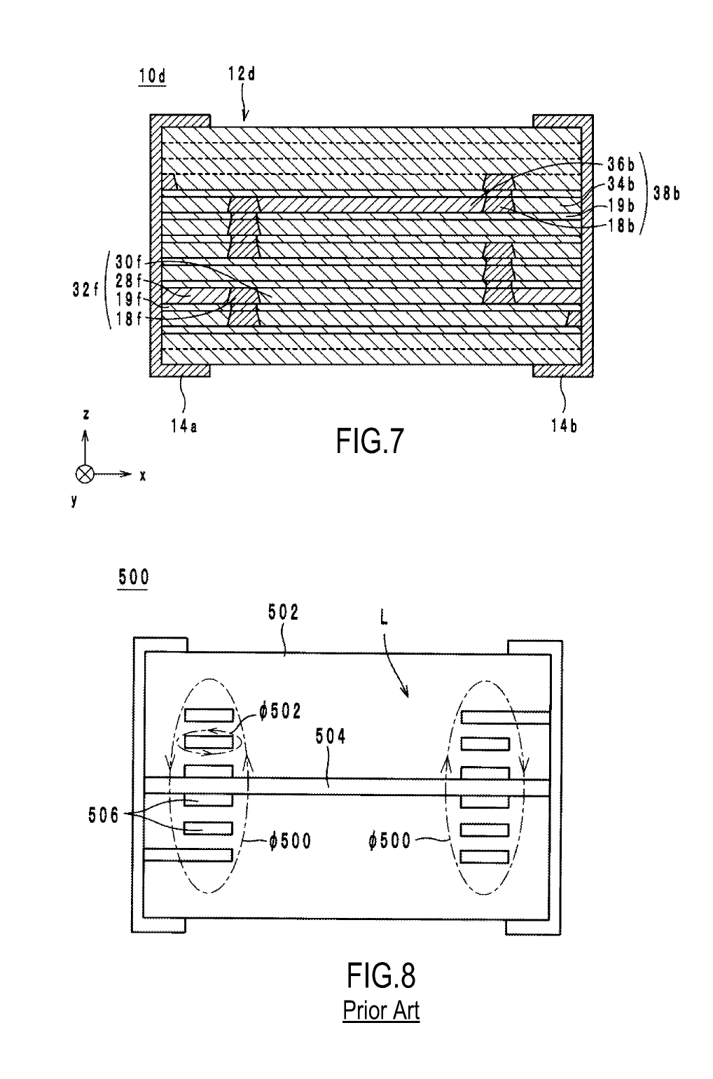

An electronic component 10d according to a third exemplary modification and an exemplary method of manufacturing the electronic component 10c are now described with reference to FIG. 7, which is a structural sectional view of the electronic component 10d according to the third exemplary modification. In order to avoid the complexity of FIG. 7, some of reference numerals representing the same members as those shown in FIG. 3, which can be present in the third exemplary modification, are not shown FIG. 7.

A first difference between the electronic component 10a and the electronic component 10d is that the electronic component 10d includes an insulating layer 36b that is non-magnetic and an insulating layer 34b that is magnetic instead of the insulating layer 16b, which is magnetic. A second difference between the electronic component 10a and the electronic component 10d is that the electronic component 10d includes an insulating layer 28f which is non-magnetic and an insulating layer 30f which is magnetic instead of the insulating layer 16f, which is magnetic.

In the electronic component 10d, the insulating layer 36b, which is non-magnetic, is placed inside a coil L and the insulating layer 28f, which is non-magnetic, is placed outside the coil L. This allows a magnetic flux y1 to pass through the insulating layers 36b and 28f, which are non-magnetic, thereby preventing magnetic saturation due to the magnetic flux φ1 from occurring in the electronic component 10d.

In the exemplary method of manufacturing the electronic component 10d, via-hole conductors b2 and b6 are formed in ceramic green sheets for forming insulating layers 19b and 19f. A procedure for forming the via-hole conductors b2 and b6 is as described above and therefore will not be repeated here.

Coil conductors 18b and 18f are formed on the ceramic green sheets for forming the insulating layers 19b and 19f. A procedure for forming the coil conductors 18b and 18f is as described above and therefore will not be repeated here.

Ceramic green layers for forming the insulating layers 34b and 36b are formed on portions of the ceramic green sheet for forming the insulating layer 19b, the portions being other than the coil conductor 18b. Ceramic green layers for forming the insulating layers 28f and 30f are formed on portions of the ceramic green sheet for forming the insulating layer 19f, the portions being other than the coil conductor 18f. In particular, the insulating layer 34b is formed on a portion of the ceramic green sheet for forming the insulating layer 19b, the portion being outside the coil conductor 18b. The insulating layer 36b is formed on a portion of the ceramic green sheet for forming the insulating layer 19b, the portion being inside the coil conductor 18b. The insulating layer 28f is formed on a portion of the ceramic green sheet for forming the insulating layer 19f, the portion being outside the coil conductor 18f. The insulating layer 30f is formed on a portion of the ceramic green sheet for forming the insulating layer 19f, the portion being inside the coil conductor 18f. The ceramic green layers for forming the insulating layers 28f and 36b are made from a non-magnetic ceramic paste (that is, a ceramic paste containing no Ni). The ceramic green layers for forming the insulating layers 30f and 34b are made from a magnetic ceramic paste (that is, a ceramic paste containing Ni). The magnetic and non-magnetic ceramic pastes are applied to the portions by a process such as screen printing or photolithography, whereby the ceramic green layers for forming the insulating layers 28f, 30f, 34b, and 36b are formed. Through the above steps, ceramic green layers for forming unit layers 38b and 32f are formed.

Ceramic green sheets for forming insulating layers 15a to 15c; ceramic green layers for forming unit layers 17a, 38b, 17c to 17e, 32f, and 17g; and ceramic green sheets for forming insulating layers 15d and 15e are stacked in that order and are then press-bonded, whereby an uncalcined mother laminate is obtained. Other steps of the method of manufacturing the electronic component 10d are the same as those of the method of manufacturing the electronic component 10a and therefore will not be described.

The electronic components 10a to 10d are prepared by a sequential press-bonding process and may be prepared by a printing process.

Embodiments consistent with the present disclosure are useful for providing an electronic component and a method of manufacturing the same. Such embodiments are excellent in being capable of preventing the occurrence of magnetic saturation due to a magnetic flux surrounding each coil conductor.

That which is claimed is:

1. An electronic component, comprising a plurality of unit layers, each said unit layer comprising:
a single sheet-shaped first insulating layer;
a coil conductor on the first insulating layer; and
a second insulating layer on a portion of the first insulating layer, the portion being other than the coil conductor, wherein
the unit layers are continuously stacked such that the coil conductors are connected to each other to form a spiral coil,
the first insulating layers include first portions sandwiched between the coil conductors in the stacking direction and second portions other than the first portions,
the first portions have a Ni content lower than a Ni content of the second portions, and
the Ni content of the second portions is lower than a Ni content of the second insulating layers.
